(19) United States
(12) Patent Application Publication
(10) Pub. No.: US 2026/0208917 A1
(43) Pub. Date: Jul. 23, 2026

(54) COLLAPSIBLE MARINADE CONTAINER

(71) Applicant: Conair LLC, Newton, MA (US)

(72) Inventors: Mark Sousa, Hope, RI (US); Wai Ho, Dedham, MA (US)

(21) Appl. No.: 19/034,067

(22) Filed: Jan. 22, 2025

(51) Int. Cl. B65D 21/08; A47J 47/08; B65D 25/38

(52) U.S. Cl. CPC B65D 21/086; A47J 47/08; B65D 25/38

(57) ABSTRACT

A container has a rigid closed bottom panel, a rigid open upper rim, and a peripheral sidewall extending between the panel and rim and flexible to enable conversion of the container between a collapsed state and a vertically extended state. A pair of rigid members are permanently and pivotally connected to the bottom panel at hinges and are pivotable about the hinges from a stored non-functional position wherein they lie under the bottom panel when the container is in the collapsed state to a functional position wherein the members engage the upper rim to secure and maintain the container in the vertically extended state.

### FIELD OF THE INVENTION

The present invention is related to marinating containers. More specifically, this invention is related to a container for marinating foods prior to cooking them and which is collapsible for reduced volume during storage.

### BACKGROUND

Marinating meats and other foods prior to cooking is a common practice, generally requiring a container deep enough to submerge the foods in the marinade. But such deep containers pose the burden of requiring significant storage space between uses and the shipping and distribution of such containers can be inefficient and costly due to their large fixed volume.

Various collapsible containers exist in the prior art but suffer from structural integrity issues because the collapsibility of the container renders it prone to collapsing inadvertently, such as when filled.

There is a need, and such is an object of the invention, to provide a collapsible marinating container that is structurally rigid when expanded for use and which prevents the inadvertent collapsing prone in the prior art.

Further needs and objects exist which are addressed by the present invention, as may become apparent upon review of the included disclosure of exemplary embodiments thereof.

### SUMMARY OF THE INVENTION

The invention may be embodied in or practiced using a collapsible marinating container having a rigid closed bottom panel, a rigid open upper rim, and a peripheral sidewall extending between the panel and rim, A pair of rigid members may be permanently and pivotally connected to the bottom panel at hinges, The peripheral sidewall may be flexible to enable conversion of the container between a collapsed state and a vertically extended state. The members may be pivotable about the hinges from a stored non-functional position wherein they lie under the bottom panel when the container is in the collapsed state to a functional position wherein the members engage the upper rim to secure and maintain the container in the vertically extended state. The hinges may be disposed on opposing sides of the panel. Base receivers may be disposed on the bottom panel for selectively engaging the members to retain them in the non-functional position. Rim receivers may be disposed on the rim for selectively engaging the members to retain them in the functional position. The peripheral sidewall may be constructed of a plurality of vertically stacked rigid and flexible rings to enable the conversion by an accordion action. A removable lid may be selectively engageable with the rim for closing the container. The bottom panel may include a drain hole, and a plug may selectively close the drain hole. The rim receivers may each be associated with one of the hinges and may be adapted for selectively engaging one of the rigid members during the functional position. Each rim receiver may be disposed vertically above its associated hinge. The base receivers may each be associated with one of the hinges and may be adapted for selectively engaging one of the rigid members during the non-functional position.

Further features and aspects of the invention are disclosed with more specificity in the Detailed Description and accompanying drawings of an exemplary embodiment provided herein.

### BRIEF DESCRIPTION OF THE DRAWINGS

Many aspects of the invention can be better understood with reference to the included Drawings showing an exemplary embodiment for practicing the invention which corresponds to the accompanying Detailed Description. The components in the Drawings are not necessarily to scale, emphasis instead being placed upon clearly illustrating the principles of the invention. Moreover, like reference numerals in the Drawings designate corresponding parts throughout the several views.

FIG. 1 is a perspective view of a collapsible marinating container according to or useful in practicing the invention in its vertically extended marinating state;

FIG. 2 is an exploded perspective view of the container of FIG. 1;

FIG. 3 perspective view of the container of FIG. 1 in its collapsed state;

FIG. 4 is a front view of the container of FIG. 1;

FIG. 5 is a front view of the container of FIG. 1 in its collapsed state;

FIG. 6 is a cross-sectional view of the container of FIG. 1 taken at Line 6-6 of FIG. 4; and

FIG. 7 is a cross-sectional view of the container of FIG. 1 taken at Line 7-7 of FIG. 5.

### DETAILED DESCRIPTION OF AN EXEMPLARY EMBODIMENT

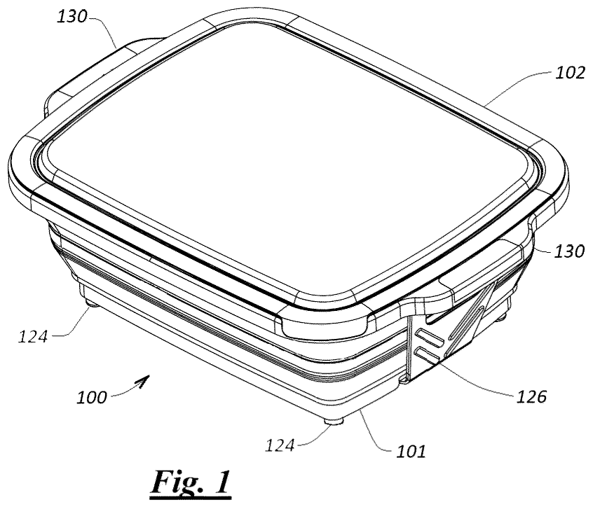

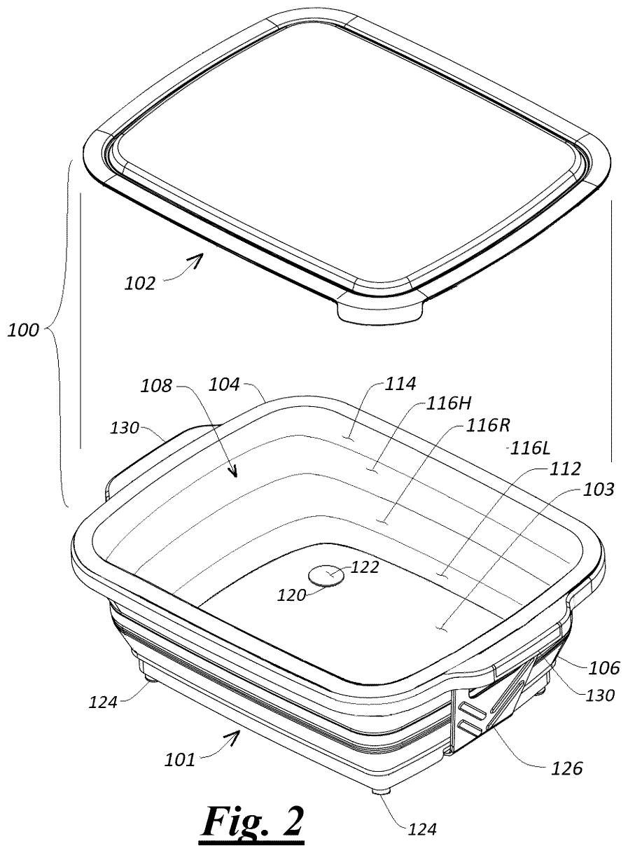

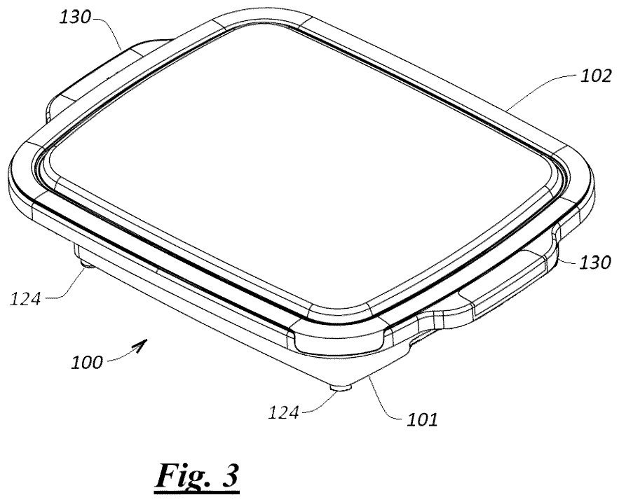

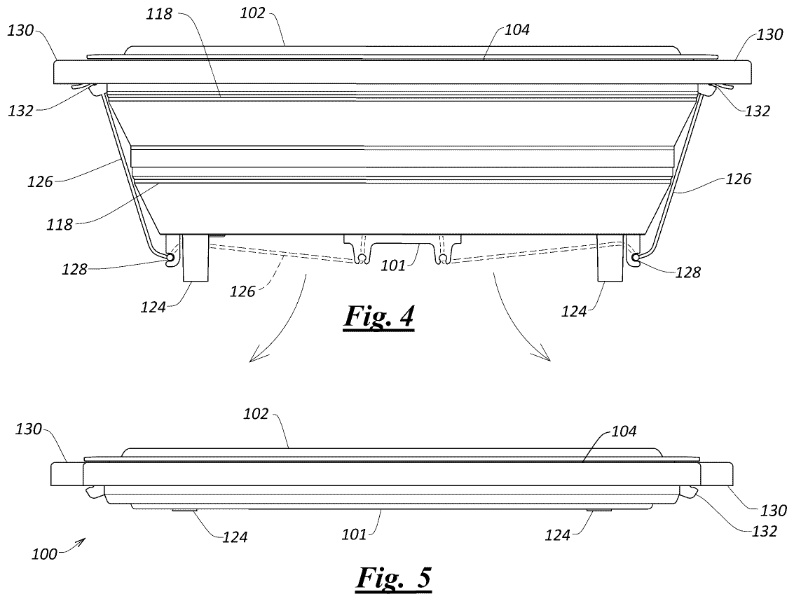

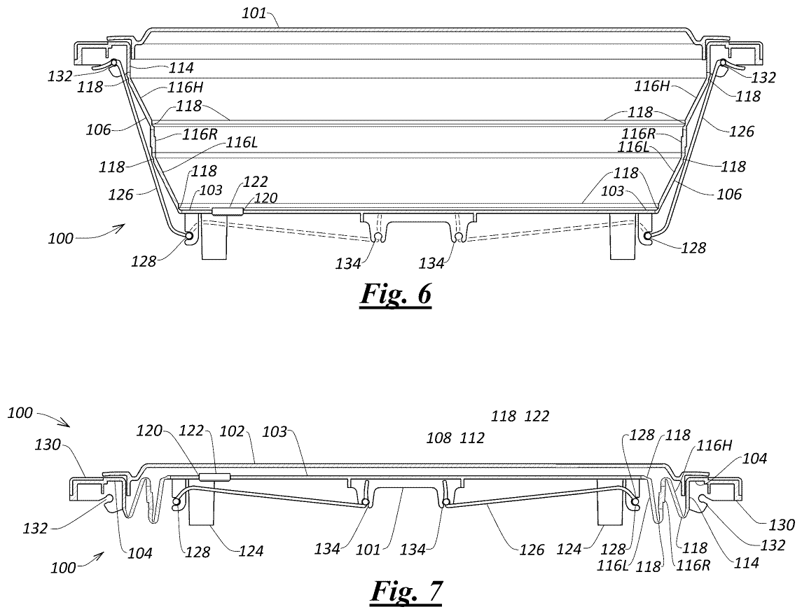

An exemplary collapsible marinating container 100 is shown in FIGS. 1 through 7, which is able to alternate between a substantially flat collapsed state, as shown in FIGS. 3, 5, and 7, and a vertically extended marinating state as shown in FIGS. 1, 2, 4, and 6. The container includes a tub 101 and a removable lid 102. The tub includes a closed bottom panel 103, an open upper peripheral rim 104, and a peripheral side wall 106 between and sealingly connected to both the closed bottom panel and the open upper rim.

In the marinating state, the peripheral side wall 106 is substantially vertical and together with the closed bottom panel and the open upper rim form a reservoir 108 for receiving food and marinade therein.

The rim and bottom panel are rigid and preferably made of polyethylene. The rim has a rigid peripheral downwardly projecting wall 114 of larger periphery than that of the bottom panel. The side wall tapers outwardly from the smaller periphery of the bottom panel wall to which the bottom of the side wall is peripherally and sealingly connected to the larger periphery of the rim peripheral wall to which the top of the side wall is peripherally and sealingly connected. The sidewall is made of vertically stacked and sealingly connected horizontal peripheral rings. The rings alternate horizontally between rigid rings preferably made of polyethylene and flexible rings preferably made of thermoplastic rubber. The sealing connections of the bottom panel, rings, and upper rim are preferably accomplished by over-molding.

The lowest ring 116L is a flexible ring and is sealingly and peripherally connected along its bottom edge to the periphery of the base panel. The highest ring 116H is a flexible ring and is sealingly and peripherally connected along its top edge to the bottom of the upper rim peripheral wall. Middle ring 116R is a rigid ring and is sealingly and peripherally connected along its bottom edge to the top edge of lowest ring 116L, and sealingly and peripherally connected along its top edge to the bottom edge of highest ring 116H. Each ring is slightly larger than the ring below it, enabling accordion-style collapsing into the collapsed state by flexure of the flexible rings as best seen in FIG. 7. Such flexure predominately occurs as a folding along peripheral grooves 118 where the rings are thinner. The grooves are strategically disposed around the flexible rings to enhance the accordion-style compaction.

The bottom panel includes a drain hole 120 with a removable plug 122. The removable horizontal lid 102 engages and selectively closes the rim to cover the reservoir.

Two rigid links 126 are permanently and pivotally connected to the bottom panel at hinges 128, which are disposed on opposing sides of the panel. The links are pivotable at the hinges from a stored non-functional position, as shown in FIGS. 3, 5, and 7, wherein they lie up against the underside of the bottom panel when the tub is in the collapsed state and are temporarily held there by selective attachment to base receivers 134, to a functional position, as shown in FIGS. 1, 2, 4, and 6, wherein the links are selectively attached to rim receivers 132 disposed on opposing sides of the upper rim directly above the associated hinges. Thus, the links can connect between the bottom panel hinges and rim receivers to secure and maintain the tub in the marinating state by ensuring that the rim and bottom panel are held apart. The base and rim receivers are adapted to release the links so that the links may be pivoted back and forth between their two states as desired.

Various changes in form and detail may be made without departing from the spirit and scope of the invention, so the invention should therefore only be considered according to the following claims, including all equivalent interpretation to which they are entitled.

1. A collapsible marinating container having a rigid closed bottom panel with a planar bottom side, a rigid open upper rim, and a peripheral sidewall extending between the panel and the rim;
a pair of rigid members permanently and pivotally connected to the bottom panel at hinges;
wherein the peripheral sidewall is flexible to enable conversion of the container between a collapsed state and a vertically-extended state;
wherein the members are pivotable about the hinges from a stored non-functional position wherein they lie under the bottom panel when the container is in the collapsed state to a functional position wherein the members engage the upper rim to secure and maintain the container in the vertically-extended state;
wherein the hinges are disposed on opposing sides of the panel;
and further comprising base receivers on the bottom panel for selectively engaging the members to retain them above the planar bottom side in the non-functional position.

2.-3. (canceled)

4. The container of claim 1 further comprising rim receivers on the rim for selectively engaging the members to retain them in the functional position.

5. The container of claim 4 wherein the peripheral sidewall comprises a plurality of vertically stacked rigid and flexible rings to enable the conversion by an accordion action.

6. The container of claim 5 further comprising a removable lid selectively engageable with the rim for closing the container.

7. The container of claim 6 wherein the bottom panel includes a drain hole and the container further comprises a plug for selectively closing the drain hole.

8. The container of claim 4 wherein the rim receivers are each associated with one of the hinges and adapted for selectively engaging one of the rigid members during the functional position.

9. The container of claim 8 wherein each rim receiver is disposed vertically above its associated hinge.

10. The container of claim 9 wherein the base receivers are each associated with one of the hinges and adapted for selectively engaging one of the rigid members during the non-functional position.

11.-18. (canceled)
